(19) United States
(12) Patent Application Publication
(10) Pub. No.: US 2014/0175787 A1
(43) Pub. Date: Jun. 26, 2014

(54) SUBSTRATE WITH SECURITY PRINT AND A METHOD TO OBTAIN IT

(71) Applicants: Jorge Bernardes, Asuncion (PY); Lourdes Bernardes Sievens, Clemmons, NC (US)

(72) Inventors: Jorge Bernardes, Asuncion (PY); Lourdes Bernardes Sievens, Clemmons, NC (US)

(21) Appl. No.: 13/880,431

(22) PCT Filed: Aug. 10, 2011
(86) PCT No.: PCT/US11/47166

§ 371 Date: Apr. 19, 2013

(30) Foreign Application Priority Data
Jun. 10, 2011 (AR) 110102019

(51) Int. Cl. B42D 15/00

(52) U.S. Cl. CPC B42D 15/00
USPC 283/85; 355/32; 101/151; 427/7

(57) ABSTRACT

A substrate with security print and a method to obtain it, which comprises a laminar substrate where color ink prints have been applied on the obverse and reverse of the substrate, whereby these prints coincide and leave an area free of print to form a watermark, and an ultraviolet ink print within said watermark, in a way that the substrate can be verified by holding it against the light to visually verify the watermark and under ultraviolet light to visually detect the ultraviolet ink print that coincides with the watermark.

### STATE OF THE ART OF THE INVENTION

### Field of the Invention

The present invention is related to the field of techniques of security prints, such as those that are implemented in security documents, on paper or any other adequate substrate, such as official documents, checks, certificates, etc. and more particularly we refer to a substrate with security print and a method to obtain the substrate.

### DESCRIPTION OF THE PRIOR ART

Documents and substrates in general that have been printed or treated in such a way that they include a security print, among which using different special inks that are optically variable, ultraviolet and invisible to the naked eye, magnetic inks, etc., are well known in the art.

Among the traditional security systems we can find the “INTAGLIO”, which consists of a direct relief print and is used very frequently for banknotes, important documents, etc. To use this system, special machines are needed, special steel matrices, special inks and a group of people specialized in this area.

Other techniques exist, such as “Dry Offset”, i.e. indirect printing, which is realized to perform what is known as the printing of coinciding images and consists in printing one part of a drawing on one side of a substrate, for example paper, and the rest on the back side, so that when it is held against the light the drawings coincide with microscopic accuracy. Border printing, guilloché, etc. are also done.

Typography is also known, mainly for the printing of numbers, and other methods such as: Silkscreen printing, Classic or Wet Offset, Flexographic printing, Gravure, Digital Printing, etc.

Furthermore, the usage of what is called “Watermark” is also well known for certain documents or simple pages of paper. A printing technique with Watermark consists in printing both sides of the paper or substrate with an image. The right side of the image is huedly printed on the front and the reverse side is printed on the back, i.e. when the paper is held against the light, the watermark can be seen which is nothing else than the unprinted surface. In other words, on the obverse a thin layer of ink is printed over the entire surface of the paper except on those areas where the watermark is required, which can be an image or a certain text. The same is done on the reverse side, without printing the area(s) of the watermark that coincide(s) with the obverse. This way the paper becomes more opaque or obscure in the areas where the printing ink is applied while the unprinted surfaces let through the light more easily and are observed as watermarks. It is preferable to use ink that has the same color as the paper or at least one that comes as close as possible.

Many type of security paper have watermarks that are included during the fabrication process and therefore are very secure. There are single-tone, two-tone and multitone watermarks. A way to obtain something similar to these watermarks, is to print a finished paper on both sides, i.e. on the obverse and reverse, with hued images which produce a similar effect. Among the advantages of these types of paper is the fact that they cannot be photocopied, even using very modern high-resolution photocopiers. It is preferable to use an ink with a color similar to that of the paper but on occasion it can have a different color.

Two important color systems are known. The subtractive color system (CMY), which corresponds to the colors cyan (blue), magenta and yellow. The subtractive colors are those that are used in printing, for example, and the sum of the three colors is black. The second system is the system of additive colors (RGB), which corresponds to red, green and blue and are used exclusively in television, monitors and lighting systems.

For example, to obtain the color green using subtractive colors, cyan is printed over yellow. Furthermore, a large amount of resources exist to obtain different tones of the same color, such as for example to obtain a light blue color, very small blue dots, called reticula, are printed, and to the human eye the illusion of a light blue tone is created. The smaller the dots and/or the further they are separated, mixed with the white paper, the more the sensation of light blue will be observed. The same happens with any other color. Red ink that is printed intermeshedly will produce an optical effect of the color pink. When performing this test with black ink the result will be gray.

In the same way that the previously mentioned resources are used in classic printing or subtractive colors, the same can be done with the primary and secondary additive colors, i.e. the colors red, green and blue are combined to obtained any tone necessary. In effect, full-color printing uses the three subtractive base colors and by mixing them, the required colors and tones are obtained. It is important to note that additive colors, which in combination form the color white, are used in television screens and video and computer monitors.

Also known is the so-called reduced traditional full color print that consists in trichromatic printing, i.e. using the three basic subtractive colors, separated in originals or different photolitographs, and printed with the selected magenta, cyan and yellow inks, but different from current commercial printing. Besides having reduced the amount of dots or having a smaller-size reticula in each of the colors, the final result is a diffuse, soft, smokey printed image, to write, seal, sign, etc.

The usage of ultraviolet inks is also known, i.e. these are invisible to the naked eye and must be submitted to ultraviolet light, black light or a Wood's lamp to be seen. In the state of the technique, the use of invisible ultraviolet inks is limited to its application in banknotes, passports, ID's, and many documents and values, where they are used as print that is invisible to the naked eye, but visible under ultraviolet light.

Considering the different alternatives and printing systems that are used in security documents, it would be very convenient to increase this security using an adequate combination of said systems in a printing pattern which allows for the visualization of security marks when held against the light, in combination with security marks and designs that are only visible when exposed to ultraviolet light.

### BRIEF DESCRIPTION OF THE INVENTION

Therefore it is an objective of the present invention to provide a new printing technology with the goal of improving security documents, wherein the document can be verified visually using invisible prints that can be detected by using backlighting, while the same document includes invisible prints in combination with said prints that can be detected by using backlighting, said invisible prints being detectable by exposition of ultraviolet light.

It is yet another objective of the present invention to provide a substrate with security print and a method to obtain it, which comprises a laminar substrate where color ink prints have been applied on the obverse and reverse of the substrate, whereby these coincide and leave an area free of print to form a watermark, and an ultraviolet ink print within said watermark, in a way that the substrate can be verified by holding it against the light to visually verify the watermark and under ultraviolet light to visually detect the ultraviolet ink print that coincides with the watermark.

It is yet another objective of the present invention to provide a substrate with security print, of the type that comprises at least a layer of ink that defines a watermark, where the substrate comprises a laminar substrate, a color ink print on the obverse of the substrate and an ink print on the reverse of the substrate, said prints coinciding and being in agreement with a printing pattern that leaves at least an area free of print, forming a watermark, and an ultraviolet ink print within said area that forms the watermark, on the obverse and on the reverse of said laminar substrate.

It if yet another objective of the present invention to provide a method to obtain a substrate with security print that comprises the following phases:

to provide a laminar substrate,

to apply a print with color ink to the obverse side of the substrate and a print with ink on the reverse side of the substrate, said prints coinciding and being in agreement with a printing pattern which leaves at least an area free of print, forming a watermark, and

to apply an ultraviolet ink print within said area that forms the watermark, on the obverse and reverse sides of said laminar substrate.

### BRIEF DESCRIPTION OF THE DRAWINGS

For greater clarity and understanding of the objective of the present invention, it has been illustrated in several figures, where the invention has been represented in one of the preferred embodiments, all by way of illustration, wherein:

FIG. 1 shows a side-section view of a substrate wherein an ink print has been applied on the obverse and reverse sides of the substrate, according to a coinciding image pattern leaving without print those areas that will define the determined watermark(s);

FIG. 2 shows a side-section view of the substrate in FIG. 1, wherein the ultraviolet ink print has been applied within the watermark areas on the obverse and reverse sides of the substrate, and

FIG. 3 shows a side-section view of the substrate in FIGS. 1 and 2, wherein a third print has been applied, also on the obverse and reverse side of the substrate, using a third layer of subtractive color ink, over the first layer of ink and the ultraviolet ink.

### DETAILED DESCRIPTION OF THE INVENTION

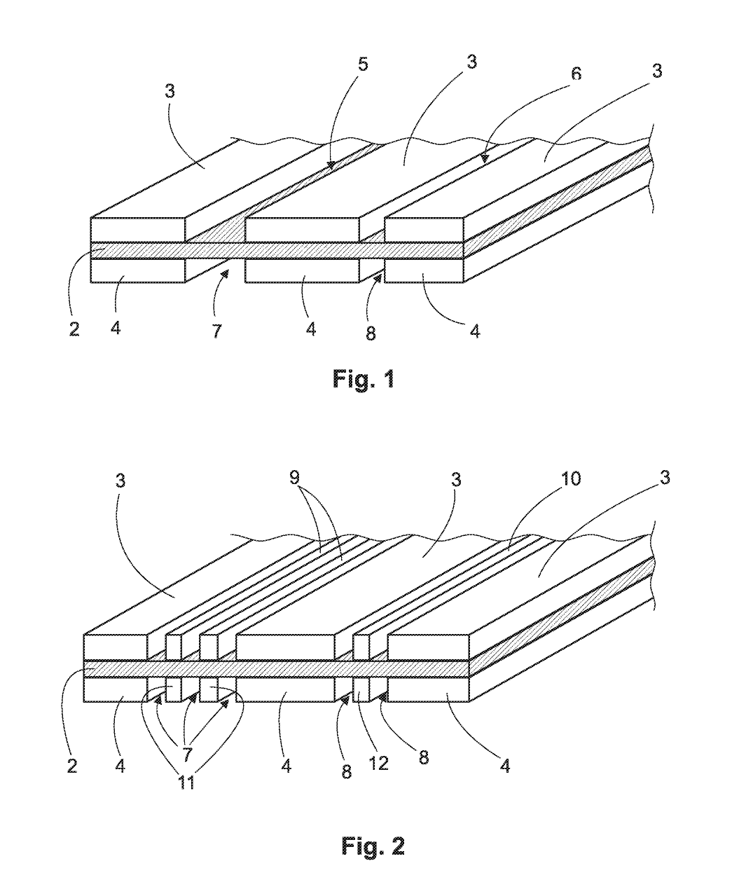

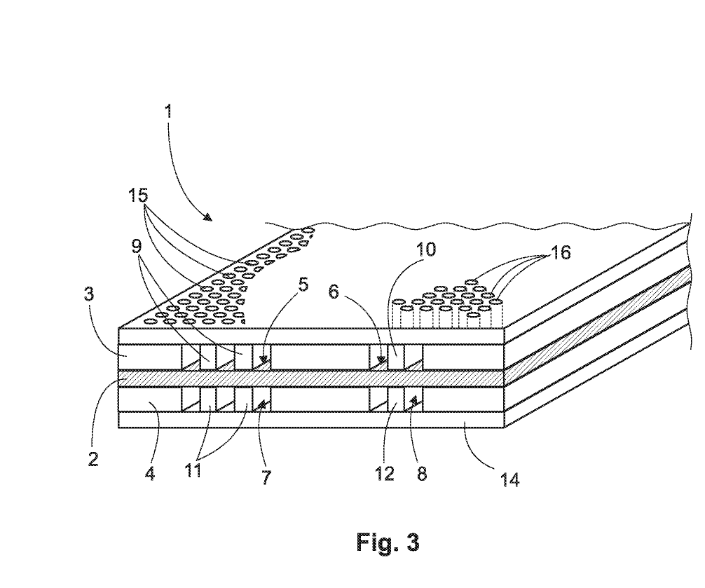

Referring in detail to the figures we can see that the invention consists in a substrate with security print, indicated with the general reference number 1 in FIG. 3. In agreement with the step to obtain, or to print the substrate of the invention, starting from FIG. 1, the security substrate consisting of a base or laminar substrate 2 which can consist of any convenient material such as paper, cloth, card stock, cardboard and the like.

Among the various papers used by the invention are printing papers such as white papers with different weights per square meter, i.e. with a different thickness, which receive names such as “bond paper”, which constitutes the majority of paper used in offices, for photocopiers, letterheads, cards, etc. This is also called surface-sized, ultra white paper. These papers contain optical brightener in the paste or pulp, achieving greater whiteness. This product produces a characteristic white fluorescence when it exposed to ultraviolet light, black light or a Wood's lamp.

Other types of paper are used, such as white papers, also having different weights, which are called security papers. Generally, it contains a mixture of rags in the production process, in combination with the cellulose. Some of these are already manufactured with watermarks using transparencies that form coats of arms, logos, letters, faces, portraits, etc. which can be easily visualized using backlighting.

In agreement with the invention, the laminar substrate 2 shows at least one layer of ink 3, 4 on the obverse and on the reverse, respectively, said prints coinciding, preferably micrometrically. Said ink prints 3, 4 can be colored, preferably using the same color or tone as the paper itself and if they include any design, that design should coincide perfectly so that, when the printed substrate is held against the light, no shift can be noticed between the obverse and reverse designs. This is called coinciding and hued printing. For this/these print layer(s), it is preferable to use covering white Offset inks, for example the Paraguayan brand GRAFEX.

The print of the ink layer 3, 4 is done coincidingly, as previously mentioned, and leaves at least an area free of print to form one or more watermarks. Considering there is no printing ink in said print-free areas, they are observed as watermarks when the substrate is held against the light. These areas are indicated using references 5, 6 on the obverse and 7, 8 on the reverse. These areas coincide and will be seen as watermarks when held up against the light.

Also in agreement with the invention, within each of said watermark areas 5-8, and preferably exclusively within each of said areas, a print is included using ultraviolet ink, preferably on the obverse and on the reverse sides of said laminar substrate. It should be understood that when an ultraviolet ink print is mentioned, this includes one or more printing areas or layers. What is important, in agreement with the invention, is that said print using ultraviolet ink is included within one or more watermark areas and preferably, without extending outside of said watermark(s). This means that it will be restricted to said area(s) that define the watermark(s). The print using UV ink will occupy part of, or the entire watermark area, as has been illustrated.

The ultraviolet ink print is indicated using references 9 and 10, within watermarks 5, 6, respectively on the obverse, and the references 11, 12 within the watermarks 7, 8 respectively, on the reverse.

It should be understood that an ultraviolet ink is an invisible ink to the naked eye but can be observed as fluorescent or visible under ultraviolet light, black light or a Wood's lamp. Ultraviolet ink can include pigments and said pigments comprise at least one of the different primary additive colors. The watermark and said ultraviolet ink prints define an image that can be a text, designs, illustrations, logos, signatures, and the like. The inks can be ultraviolet invisible Offset inks, for example those of the U.S. Gans Ink & Supply Co.

When printing with ultraviolet invisible inks, in agreement with the invention, the print-free areas 5-8, a great variety of colors is obtained that are only visible under ultraviolet light. Considering the printing of the obverse and reverse sides is done with the same ultraviolet ink, the colors will not only be observed on both sides under ultraviolet light, but also when holding the paper or substrate against the ultraviolet light. This way, the invisible ultraviolet inks produce the effect of a colored watermark, against ultraviolet light.

A printing layer of color ink 13, 14, based on the range of subtractive colors, is incorporated over the color ink prints 3, 4 and the ultraviolet ink 9-12, on the obverse and reverse sides of the substrate. This way, in agreement with an aspect of the invention, a printing combination is obtained that uses two color systems, additive and subtractive, whereby one is visible under natural light and one under ultraviolet light, preferably using an ultraviolet electromagnetic radiation with a wavelength that is higher than 350 nanometers.

The ink print 13, 14 is preferably done using three-color inks, Cyan, Magenta and Yellow, with the coinciding image of a selection of colors or a full-color photography, drawing, painting, etc. and with a subtle reduced mode by minimizing the dots, reticula or pixels, so it can be written, signed, sealed, etc. These pixels or reticula are indicated with references 15, 16 in FIG. 3. Hidden microtexts can be inserted on both sides of these prints, as well as some printing errors ex professo.

This print 13, 14 on both sides of the paper, with the subtle color selection and perfect register protects everything that is printed below or before and consequently the following optical effects are obtained:

Under visible natural or artificial light:

a. —Image of a landscape, face, building, flag, coat of arms, emblem, etc.

b. —The watermarks are observed when held against the light or backlit.

Under ultraviolet light or black light:

c. —The same watermark images are visualized on both sides of the paper in beautiful colors. When held against ultraviolet light, the magical colors can also be observed. This is different from the usage that the prior art makes of ultraviolet inks which are applied on one side and are visible because of the reflection of the light on that one side.

These effects are also contemplated separately, in agreement with the invention.

In agreement with another aspect of the invention, the security substrate combines two different color systems, i.e.:

The subtractive color prints (CMY); Cyan, Magenta and Yellow, the combinations of which produce all colors and the overlay of all three produces the color black. This constitutes the traditional systems of the printing inks, dyes, colorants, etc.

There is another usage for the colors that correspond to the primary additive colors (RGB) Red, Green and Blue, the combination of which produces all the others and the overlay of all three produces the color white. These colors are not used in printing this way, they are applied in television screens and computer monitors.

The present invention is applied for example, without being exclusive, in the personalization of checks, stock, certificates, bonds, operating permits, banknotes, etc.

One of the advantages of the present invention is that traditional security papers can be used and personalized using the invention's method, in order to obtain an excellent quality reproduction, which is very difficult to reproduce without using special inks and machines as those used in Mints.

The security substrate of the invention has been obtained using an traditional wet Offset printer of the brand “HEIDELBERG”, in two parts. However, in order to comply with the most demanding security requirements, exclusive machines will have to be used that are not accessible to the general public. A machine that is recommended for these types of jobs is the “Leterset” or “Dry Offset”, with Perfect Registration and Coinciding Image mode, generally used by Mints.

Consequently, the features of the invention can be synthesized in three combined and independent concepts:

1. The usage of ultraviolet inks that are invisible under natural light but can be seen under ultraviolet light, that produce a colored watermark when submitted to ultraviolet light, black light or a Wood's lamp.

2. The result of a printed watermark, visible under ultraviolet light, i.e. a colored watermark.

3. The combination of the two color systems, i.e. the primary additive colors and the primary subtractive colors for printing. In other words, a print on the same substrate or paper of the systems of primary additive and subtractive colors by using conventional printing techniques and the printing of colors that are only used for television screens and computer monitors.

With regards to the technique to obtain the new security substrate of the invention, it can be added that the first print on the obverse side of the paper is done using photolitographs or hued film, i.e. in the form of a negative, to copy the right side of the plates, which has left a thin layer or film 3 of white ink over the entire surface of the paper 2, except for the print-free sections 5, 6, in the shape of drawings and letters.

The second print 4 on the reverse of the paper 2 has been done similarly to the previous, but using the inverted photolitograph with perfect registration, in such a way that the print-free parts 7, 8 coincide micrometrically with parts 5, 6 on the other side. Just like on the obverse, a thin layer or film of paint is also applied here which, in combination with the previous, turns the printed surface more opaque, making the unprinted areas, the letters, drawings, etc., i.e. the watermarks more transparent. The effect obtained is known as coinciding image in security printing. Using this technique, watermarks can be obtained of texts, drawings, images, portraits, photographies, coats of arms, logos, etc. As explained before, the machines for a guaranteed first-rate print are those used by the Mints which print both sides simultaneously using the coinciding image mode.

Once these first prints have been applied to the obverse and reverse, each side is printed with the same micrometric precision using each color of the ultraviolet ink that is invisible under natural light but visible under ultraviolet light. In order to obtain the different color tones, we use the knowledge of mixing the primary additive colors, i.e. different percentages of reticula and their combination with others of an another color. Using these resources, a lot of different colors can be obtained. In agreement with the invention, this combination of watermark with invisible ultraviolet ink print provides a customized color and design combination which produces the effect of a watermark that is visible when being held up against ultraviolet light.

Finally, a full-color image is printed on both sides of the paper using the coinciding image mode, such as a photography, portrait, etc., using a three-color process. These prints are done using Offset printing, very common in printing, but with the highly novel technique proposed by this invention, including printing with reduced reticula or pixels, in order to obtain a degraded, pale image as a security background, on which it is possible to print, sign, seal, etc. as if it were a blank page.

In conclusion, the security substrate or document that is obtained in agreement with the invention shows the following characteristics or features:

If the paper is observed under direct light from both sides, only the image with reduced or subtle colors can be seen.

When observing the same piece of paper from both sides, having the light come in from a perpendicular angle, i.e. backlighting, the watermark can be observed.

If it is held up against the ultraviolet light, the watermark can be observed in beautiful full-color.

In comparison to the different security printing investigations performed in different countries and including known and observed highly secure documents, the inventors have come to the conclusion that the use of ultraviolet inks that are invisible to the naked eye but which can be seen under ultraviolet light or black light, is limited to its printing in several colors, but on only one side of the paper or both, to be seen in the reflection of light that comes from the opposing side of the paper. In other words, it is exclusively a security measure to avoid forgery.

In the current state of the technique, there is no knowledge of the usage of invisible inks to reproduce color images that are visible using ultraviolet backlighting, using ultraviolet full-color images or photographies, printed on both sides as a coinciding image. Besides printing both sides of the paper using the “coinciding image mode”, these prints are used in an additive combination mode as is done in television screens or computer monitors. For example, in order to visualize the color yellow, besides using this color, another option is to print green and red ink dots, which create the optical illusion of the color yellow to the human eye. This is very important, as an immense amount of tones can be created starting from the three basic colors (red, green and blue). Its usage as an element of maximum security, besides creating beautiful color images, which even seem “magical’, this opens the door to an unknown world of printing, in both traditional systems (CMY) and (RGB), colors that are used in traditional printing and in computers respectively.

We claim:

1. A substrate with security print, of the type containing at least a layer of ink that defines a watermark, comprising:
a laminar substrate,
a print with color ink to the obverse side of the substrate and a print with color ink on the reverse side of the substrate, said prints coinciding and being in agreement with a printing pattern which leaves at least an area free of print, forming said watermark, and
an ultraviolet ink print within said area that forms the watermark, on the obverse and reverse sides of said laminar substrate.

2. The substrate of claim 1, wherein a layer of color is applied onto said prints with color ink and ultraviolet ink on the obverse and reverse sides of the substrate, the layer of color being based on the subtractive colors.

3. The substrate of claim 1, wherein said laminar substrate is selected from the group consisting of paper, cloth, card stock, cardboard and the like.

4. The substrate of claim 2, wherein said color ink has the same color as the substrate.

5. The substrate of claim 1, wherein said ultraviolet ink includes pigments.

6. The substrate of claim 5, wherein said pigments comprise at least one of the different primary additive colors.

7. The substrate of claim 1, wherein said print with ultraviolet ink is restricted to said area that defines the watermark.

8. The substrate of claim 1, wherein said watermark and said print using ultraviolet ink define an image selected from the group consisting of text, designs, illustrations, logos, signatures and the like.

9. A method to obtain a substrate with security print, the method comprising:
providing a laminar substrate,
applying a print with color ink to an obverse side of the substrate and a print with color ink on a reverse side of the substrate, said prints coinciding and being in agreement with a printing pattern which leaves at least an area free of print, forming a watermark, and
applying an ultraviolet ink print within said area that forms the watermark, on the obverse and reverse sides of said laminar substrate.

10. The method of claim 9, wherein a layer of color is applied onto said prints with color ink and ultraviolet ink on the obverse and reverse sides of the substrate, the layer of color being based on subtractive colors.

11. The method of claim 9, wherein said color ink print on the obverse of the substrate and said ink print on the reverse of the substrate being realized using photolitographs, respectively inverted and with micrometric registration.

12. The method of claim 9, wherein said color ink prints being realized using a dry Offset printing technique.

13. The method of claim 9, wherein said ultraviolet ink print being realized using an Offset printing technique, with coinciding image and color tones by intermeshing.

14. The method of claim 10, wherein said application of the color layer based on subtractive colors being realized using an Offset printing technique, with coinciding image and color tones by intermeshing.
